(19) United States
(12) Patent Application Publication
(10) Pub. No.: US 2003/0047717 A1
(43) Pub. Date: Mar. 13, 2003

(54) Multi-doped nickel oxide cathode material

(76) Inventors: Jaekook Kim, Naperville, IL (US); Donald R. Vissers, Naperville, IL (US); Khalil Amine, Downers Grove, IL (US)

Correspondence Address: Harry M. Levy, Esq., Emrich & Dithmar, Suite 3000, 300 South Wacker Drive, Chicago, IL, 60606, US

(21) Appl. No.: 09/942,190

(22) Filed: Aug. 28, 2001

(51) Int. Cl. H01B 1/00; H01C 1/00

(52) U.S. Cl. 252/500

(57) ABSTRACT

A cathode material and processes of preparation, including the composition, the steps of mixing and heating to obtain a crystallographically phase pure layered material which is a substituted lithium nickel oxide compositions of LiᵤNiᵥTi_{w}AlₓCo_{y}O_{z}, where u is between about 0.8 and about 1.2, the v is between about 0.5 and about 0.99, w is between about 0.01 and about 0.5, x is between about 0.00 and about 0.5, y is between about 0.00 and about 0.5, and z is between about 1.8 and 2.3. Such a substituted lithium nickel oxide may be used for energy conversion and storage, particularly for high power application.

### CONTRACTUAL ORIGIN OF THE INVENTION

The United States Government has rights in this invention pursuant to Contract No. W-31-109-ENG-38 between the U.S. Department of Energy (DOE) and The University of Chicago representing Argonne National Laboratory.

### FIELD OF THE INVENTION

The present invention relates to positive electrode compositions useful for energy conversion and storage, for example for lithium batteries. More specifically, the present invention relates to compositions of substituted lithium nickel oxides useful for high energy density lithium batteries as well as high power batteries.

### BACKGROUND OF THE INVENTION

Much attention has been given, particularly in recent years, to the lithium-ion battery technology for various kinds of power sources, and a reasonably clear picture of the chemical and electrochemical reactions involved have been developed. Several attempts have been made to apply this technology but the cathode material has always been considered a major problem.

The LiMO₂ (M═Co or Ni) type materials have been demonstrated to be promising 4V cathode materials, and more especially for the lithium-ion battery with carbon as an anode material. LiMO₂ oxides have an identical structure as α-NaFeO₂. The Li⁺ and M³⁺ ions in the LiMO₂ occupy alternate (111) planes in the structure with -A -B-C-A-B-C- type stacking to give a layer sequence of —O—Li—O—M—O— along the c-axis. The extraction and insertion of Li⁺ ions reversibly can take place in the lithium plane, and the 2-dimensional movement has the advantage of a relatively high diffusion coefficients of 10⁻⁷-10⁻⁹ cm²/sec. In addition, the direct interactions of M—M and 90° M—O—M in the octahedral arrangement of edge shared MO₆ suggest good electrical conductivity as well.

The LiNiO₂ is a quite attractive cathode material with its lower cost and larger capacity compared with LiCoO₂, which is predominant in todays market. However, the difficulty in preparation of phase pure LiNiO₂ and its poor electrochemical performance has hindered the commercialization of this cathode material despite its advantages.

The stabilized LiNiO₂ materials have gained widespread acceptance for high energy density or high power applications. The basic idea was the concept of developing mixed phases of isostructural LiNiO₂ and LiCoO₂, which is more stable structurally and electrochemically. The LiNi₁₋ₓCoₓO₂ materials show a capacity of up to 180 mAh/g with good cyclability.

A successful development of LiNi₁₋ₓCoₓO₂ cathodes has stimulated several other investigations such as Al and Mn. The purpose of these substitutions is to strictly manage and maintain the oxidation states of the cations around 3+, so that no unexpected structural interference happens. However, even after substitution of Ni by trivalent ions, divalent Ni²⁺ may form when the materials have undergone high temperature heating preparation or electrochemical cycling. So the chemical formula of LiNi₁₋ₓCoₓO₂ should be written as LiNi₁₋ₓCoₓO_{2-y} more accurately, and the average oxidation state of the transition metal ions are lower than 3+. It means that some portion of the lithium ions will displaced from the metal ion plane and Ni²⁺ may be substituted in the lithium lattice under extended cycling.

It is known that the instability of LiNiO₂ is mainly due to the formation or presence of Ni²⁺ ions during preparation or electrochemical cycling. Since redox reaction of Ni^{2+/3+} couple occurs at a higher potential than other transition metals, it is reasonable to believe that the Ni³⁺ ions are much more unstable compared to, for example, Co³⁺ and thus the formation of Ni²⁺ ions are almost unavoidable.

### SUMMARY OF THE INVENTION

The present invention involves various chemical methods to synthesize layered and phase pure lithium nickel oxides having a general formula LiᵤNiᵥTi_{w}AlₓCo_{y}O_{z}, where the u is between about 0.8 and about 1.2, the v is between about 0.5 and about 0.99, the w is between about 0.01 and about 0.5, the x is between about 0.00 and about 0.5, the y is between about 0.00 and about 0.5, and z is between about 1.8 and 2.3. This cathode system is prepared by partial substitution of tetravalent titanium to provide a clear impurity-free lithium layer, while cobalt, if present, helps to maintain the layered structure, and aluminum, if present, helps to improve safety. The processes include any of the traditional solid state reaction, sol-gel, or co-precipitation methods. The values of u,v,w,x,y, and z in LiᵤNiᵥTi_{w}AlₓCo_{y}O_{z} system depend on ratio of reactants and heating conditions, and with benefit of this disclosure may be varied by those skilled in the art to achieve compositions having a variety of desired properties. In one embodiment, the disclosed compositions show excellent performance as positive electrodes (cathodes) in lithium batteries. The electrochemical characteristics of these cathodes also suggest possible use in both high energy density and high power battery applications.

The presence of tetravalent titanium ions, intimately mixed at the molecular level, in LiᵤNiᵥTi_{w}AlₓCo_{y}O_{z} helps to overcome the difficulties posed by the formation of divalent nickel ions and leads to better electrochemical performance with higher capacities and better cycle lifes.

FIG. 1(a) shows a schematic representation (not crystallographic) of the ideal structure of LiNiO₂ type materials. The oxygen ions are represented as a half of oxygen, in other words 1 negatively charged object. Actually, a synthesis of the ideal stoichiometric LiNiO₂ phase is generally known to be very difficult, and it is formed as a partially disordered Li₁₋ₓNi₁₊ₓO₂. A series of careful crystallographic studies suggest that the excess nickel ions in Li₁₋ₓNi₁₊O₂ are present in the lithium planes as shown in FIG. 1(b). These Ni²⁺ ions in the lithium-ion layered structure hinder the smooth transport of lithium ions through the lithium plane, which result in poor power and cycle life.

Consequently, over the last few years, several methods have been developed to stabilize the LiNiO₂. Generally, a partial substitution of trivalent Co for Ni to give LiNi₁₋ₓCoₓO₂ has been used to overcome the difficulties in preparing phase pure materials and the ensuing electrochemical instability. A method which provided excess lithium to compensate for the loss of lithium due to the high vapor pressure of lithium during its high temperature preparation also gave stoichiometric LiNiO₂.

The stabilized LiNiO₂ with the chemical formula of LiNi₁₋ₓCoₓO₂ shows much improved electrochemical characteristics. However, some lithium ions will be removed and separated from the solid structure and Ni²⁺ will be substituted for lithium defects under extended cycling as shown in FIG. 1(c).

Our invention is the addition of tetravalent ions such as Ti⁴⁺ even though Ti is electrically inert to compensate for the electronic charge deficit and the structural instability due to Ni^{2°}. As illustrated schematically in FIG. 4(d), the substitution of Ni²⁺ ions by tetravalent Ti⁴⁺ ions appears to maintain overall electronic neutrality and structural integrity as well.

In the present invention, we demonstrated the formation of a new phase of LiᵤNiᵥTi_{w}AlₓCo_{y}O_{z}, with the molar concentrations before mentioned. The significance of this substitution together with supporting electrochemical data furnish the basis for this invention. The resulting LiᵤNiᵥTi_{w}AlₓCo_{y}O_{z} cathode materials show excellent electrochemical performance, which translates into an energy density that exceeds that of the current commercially utilized lithium cobalt oxide.

In a broad sense, the invention includes a cathode and method for developing high performance lithium nickel oxide electrodes by compensating for the formation of divalent nickel ions by substituting tetravalent titanium ions. This aspect is clearly distinct from present methods to stabilize lithium nickel oxides, in which solid solutions of iso-structural LiNiO₂ and LiCoO₂ or LiAlO₂ are prepared.

In other aspects, our patent involves a method for preparing a composition including combining various lithium salts with transition metal salts (nitrates, acetates, carbonates, hydroxides, chlorides, oxides etc.) with or without solution media such as acetic acid, adiphic acid etc. The lithium, nickel, titanium, aluminum, and cobalt may be combined in a molar ratio of from about 0.9:0.5:0.01:0.00:0.00 to about 1.1:0.97:0.5:0.5:0.5. The method also includes heating the substituted lithium nickel oxides under an air or oxygen stream to a temperature of between about 550° C. to 95020 C. to form the material.

In other aspects, the substituted lithium nickel oxide may be heated for between 0.5 hours and 7 days. The lithium salt may include lithium hydroxide. The transition metal salts may include nickel hydroxide, titanium oxides (anatase form), aluminum hydroxide, and cobalt hydroxide.

In another aspect, the invention is a method for forming an electrode by combining lithium and transition and non-transition metal salts to obtain an intimately mixed precursor, heating the precursor; and grinding the crystalline substituted lithium nickel oxides to form the electrode. The method may also include mixing the substituted lithium nickel oxides with a conducting material, which may include carbon. The method also includes mixing the substituted lithium nickel oxides with a binding agent. The grinding of the substituted lithium nickel oxides to form the electrode may include ball milling. The substituted lithium nickel oxides may be ball milled with between about 5 and 40 weight percent carbon. The method may also include mixing the substituted lithium nickel oxides with between about 1 weight percent and about 20 weight percent of a suitable binder, such as polyvinylidenefluoride(PVDF) or polytetrafluoroethylene(PTFE).

In other aspects, the invention includes the composition of the electrode which may also include between about 5 weight percent carbon and about 40 weight percent carbon and between about 1 weight percent polyvinylidenefluoride(PVDF) or polytetrafluoroethylene(PTFE) and 20 weight percent polyvinylidenefluoride(PVDF) or polytetrafluoroethylene(PTFE). The substituted lithium nickel oxides LiᵤNiᵥTi_{w}AlₓCo_{y}O_{z} may be crystalline.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

### BRIEF DESCRIPTION OF THE DRAWINGS

FIG. 1 shows schematic representations of substituted lithium nickel oxide systems; (a) ideal layered LiNiO₂, (b) actual Li₁₋ₓNi₁₊ₓO₂, (c) trivalent ion substitution, and (d) tetravalent ion substitution showing Ti⁴⁺ substitution compensating Ni²⁺ impurity ions;

FIG. 2 shows X-ray powder diffraction patterns of the substituted lithium nickel oxides LiᵤNiᵥTi_{w}AlₓCo_{y}O_{z} according to one embodiment of the present disclosure obtained by heating the mixtures of lithium salts and transition metal salts: (a) LiNi_{0 92}Ti_{0.05}Al_{0.03}O₂, (b) LiNi_{0.90}Ti_{0.05}Al_{0.05}O₂, (c) LiNi_{0.87}Ti_{0.10}Al_{0.03}O₂, and (d) LiNi_{0.85}Ti_{0.10}Al_{0.05}O₂;

FIG. 3 shows cyclic voltammetric curves of LiNi_{0.92}Ti_{0.05}Al_{0.03}O₂ and LiNi_{0.85}Ti_{0.10}Al_{0.05}O₂ with a sweep rate of 100 mV/s;

FIG. 4 shows electrochemical charge-discharge curves of the substituted lithium nickel oxides LiᵤNiᵥTi_{w}AlₓCo_{y}O_{z} recorded with a current density of 0.2 mA/cm², for electrodes prepared according to one embodiment of the present disclosure;

FIG. 5 shows the graphical relationship of capacity and electrochemical cyclabilities of substituted lithium nickel oxides LiᵤNiᵥTi_{w}AlₓCo_{y}O_{z} for various compositions: (a) LiNi_{0.92}Ti_{0.05}Al_{0 03}O₂, (b) LiNi_{0.90}Ti_{0.05}Al_{0.05}O₂, (c) LiNi_{0.87}Ti_{0.10}Al_{0.03}O₂, and (d) LiNi_{0.85}Ti_{0.10}Al_{0.05}O₂;

FIG. 6 shows cell area specific impedance during 18 seconds discharge and 2 seconds charge pulses as a function of depth of discharge (DOD);

FIG. 7 shows charge and discharge power capability as a function of depth of discharge (DOD) for cells;

FIG. 8 is a SEM image of LiNi_{0.90}Ti_{0.05}Al_{0.05}O₂ indicating very spherical morphology, resulting in excellent electrochemical and safety characteristics;

FIG. 9 is a graphical representation of aging results of an electrode material of the present invention;

FIG. 10 is a x-ray photoelectron spectroscopy data showing an inventive material with Ti⁴⁺ ions; and the binding energy of Ti³⁺; and

FIG. 11 is a schematic representation of a battery using the novel electrode materials.

### DESCRIPTION OF PREFERRED EMBODIMENTS

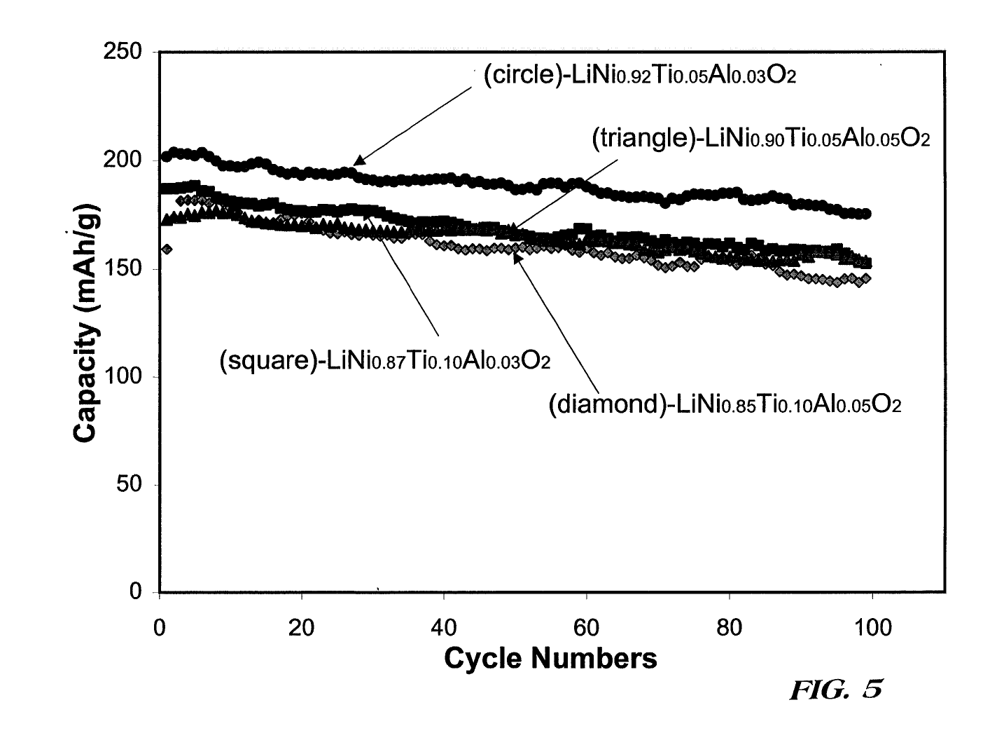

An exemplary embodiment of the presently disclosed method and composition comprises a synthesis of the substituted lithium nickel oxides LiᵤNiᵥTi_{w}AlₓCo_{y}O_{z} that is useful for energy conversion and storage devices. In an exemplary embodiment, the substituted lithium nickel oxides LiᵤNiᵥTi_{w}AlₓCo_{y}O_{z} may be crystalline. The electrochemical performance of the substituted lithium nickel oxides LiᵤNiᵥTi_{w}AlₓCo_{y}O_{z} depend upon their composition, in other words, the amount of substituted nickel by titanium, aluminum, if present, and cobalt, if present, which in turn depend, in part, upon molar ratios within the reaction mixture and heating conditions. In several embodiments, the substituted lithium nickel oxides LiᵤNiᵥTi_{w}AlₓCo_{y}O_{z} prepared in accordance with the present invention exhibit capacities of about 150-240 mAh/g (see FIG. 5) depend upon composition, synthesis conditions, and electrochemical conditions such as current densities and cutoff voltages.

In the invention, a lithium salt is combined with transition metal salts to form the substituted lithium nickel oxides LiᵤNiᵥTi_{w}AlₓCo_{y}O_{z}. The mixing of the lithium and transition metal salts may be done by ball milling or grinding. The lithium salt may be a lithium hydroxide or may be one or more other suitable lithium salts, including, but not limited to lithium nitrates, acetates, carbonate, oxide or mixture thereof. The transition metal ions may come from nickel hydroxide, titanium oxide (anatase form), aluminum hydroxide, and cobalt hydroxide, or from other suitable transition metal salts, including, but not limited to, transition metal nitrates, acetates, carbonates, oxides or mixture thereof. In the invention, Li, Ni and Ti are always present with Al and/or Co being optional.

In one method, the reaction mixture after mixing using ball milling or grinding may be heated at a suitable temperature and/or for a time suitable for forming phase pure crystalline substituted lithium nickel oxides LiᵤNiᵥTi_{w}AlₓCo_{y}O_{z}. For example, a temperature of from about 550° C. to about 950° C. for a time period of from 0.5 hours to about 7 days may be employed. Varying amounts of lithium and transition metal salts may be mixed together to form the substituted lithium nickel oxides LiᵤNiᵥTi_{w}AlₓCo_{y}O_{z} so that the composition of the substituted lithium nickel oxides LiᵤNiᵥTi_{w}AlₓCo_{y}O_{z} may be adjusted as desired. As used herein, “mixing” refers to any suitable methods of general mixing, but not limited to, ball milling, grinding, stirring, shaking, blending, etc. In one embodiment, 5-10% of titanium and 3-5% of aluminum ions replace corresponding amounts of nickel ions. However, it is contemplated that alternative, suitable molar ratios of lithium and transition metal salts may be employed including ratios of LiᵤNiᵥTi_{w}AlₓCo_{y}O_{z}, where the u is between about 0.8 and about 1.2, the v is between about 0.5 and about 0.99, the w is between about 0.01 and about 0.5, the x is between about 0.00 and about 0.5, and the y is between about 0.00 and about 0.5, and z is between about 1.8 and 2.3. In this regard, with benefit of this disclosure, those with skill in the art will understand that compositions having varied molar ratios may be prepared by varying the amount of reactant and/or synthesis condition.

The mixture may be annealed, for example, at an elevated temperature. In this case, the heating process tends to remove any organic substance from reactants, residual moisture, or any adsorbed water to form a pure crystalline phase. In one embodiment, the mixture may be heated at around 750° C. in an oxygen stream. Heating may also take place under various conditions (e.g., in oxygen, inert atmosphere or in an air). In another embodiment, the heating temperature may range from about 550° C. to about 950° C. for a time period of from 0.5 hours to about 7 days. With the benefit of this disclosure, those with skill in the art will understand that any heating temperature suitable to form well ordered layered and phase pure structure may be employed.

The substituted lithium nickel oxides LiᵤNiᵥTi_{w}AlₓCo_{y}O_{z} formed from heating may be further processed by, for example, grinding to form an electrode. As used herein, “grinding” refers to mixing, crushing, pulverizing, pressing together, polishing, reducing to powder or small fragments, milling, ball milling, or any other suitable process to break down a material. The conducting material in the electrode preparation may be an electrically conductive materials such as carbon, which may be in the form graphite or acetylene black, but it will be understood with benefit of this disclosure that the conducting material may alternatively be any other suitable material or mixtures of suitable materials known in the art. In one embodiment, the synthesized substituted lithium nickel oxides LiᵤNiᵥTi_{w}AlₓCo_{y}O_{z} formed from heating may be mixed with between about 5 weight percent and about 40 weight percent carbon. Mixing may be performed for various intervals of time, and in this case, about 30 minutes. It will be understand that mixing times may be varied as desired to suit particular mixing processes and product specifications. The substituted lithium nickel oxides LiᵤNiᵥTi_{w}AlₓCo_{y}O_{z} formed from heating may also be mixed with 2-15 wt % of a binding material including, but not limited to, polyvinylidenefluoride (PVDF) or polytetrafluoroethylene (PTFE). It is contemplated that other binding materials known in the art may be substituted for polyvinylidenefluoride (PVDF) or polytetrafluoroethylene (PTFE).

With the benefit of this disclosure, the mixed, crushed, and/or ground materials may be fabricated into one or more Li-ion battery cathodes for energy conversion and storage according to procedures known in this regard to those skilled in the art. An example of forming a battery electrode and battery is described in U.S. Pat. No. 5,419,986, which is incorporated by reference herein in its entirety.

Electrodes may be formed in a variety of shapes, sizes, and/or configurations as is known in the art. In one embodiment, an electrode may be formed by laminating a mixture of the substituted lithium nickel oxides LiᵤNiᵥTi_{w}AlₓCo_{y}O_{z}, conducting material, and binding material on aluminum metal substrates which may be cut to form, for example, circular electrodes having an area of about 1.6 cm² with a thickness of about 0.02-0.10 mm and a mass of about 0.01-0.05 g. In other embodiments, the form of electrode may be varied by using different techniques, such as using single mass or using metallic mesh for a current collector. Electrochemical performance of such electrodes may be evaluated according to procedures known in the art. In one example, the electrochemical performance of such electrodes may be evaluated with coin-type cells using metallic lithium or carbon anodes and LiPF₆ salt in ethylene carbonate (EC)/diethyl carbonate (DEC) with 1:1 volume ratio as electrolyte.

The following examples are illustrative of the invention and should not be construed as limiting the scope of the invention or claims thereof.

### EXAMPLE 1

### Synthesis of the Substituted Lithium Nickel Oxides LiᵤNiᵥTi_{w}AlₓCo_{y}Oz

The required amounts of raw material powders such as lithium hydroxide, nickel hydroxide, titanium oxide (anatase), aluminum hydroxide and cobalt hydroxide were mixed together by ball-milling for 24 hours. The resulting mixture was then heated and fired in an oxygen or air stream. The substituted lithium nickel oxides LiᵤNiᵥTi_{w}AlₓCo_{y}O_{z} formed from heating were then ground and mixed with carbon as a contact agent. Chemical compositions of the substituted lithium nickel oxides LiᵤNiᵥTi_{w}AlₓCo_{y}O_{z} prepared in this example are listed in Table 1. The Inductively Coupled Plasma (ICP) analytical results also confirmed the chemical compositions.

TABLE 1. Compositions of the Substituted Lithium Nickel Oxides LiᵥNi_{w}TiₓAl_{y}O_{z} obtained with Various Amounts of Titanium and Aluminum Ions.

| Sample Number | Chemical Composition |
|---|---|
| 1 | LiNi_{0.92}Ti_{0.05}Al_{0.03}O₂ |
| 2 | LiNi_{0.90}Ti_{0.05}Al_{0.05}O₂ |
| 3 | LiNi_{0.87}Ti_{0.10}Al_{0.03}O₂ |
| 4 | LiNi_{0.85}Ti_{0.10}Al_{0.05}O₂ |

As before stated, the molar concentrations of the various constituents may be varied, where u is between about 0.8 and about 1.2, the V is between about 0.5 and about 0.99, the w is between about 0.01 and about 0.5, the x is between about 0.00 and about 0.5, the y is between about 0.00 and about 0.5, and z is between about 1.8 and 2.3.

### EXAMPLE 2

### Characterization of the Substituted Lithium Nickel Oxides LiᵤNiᵥTi_{w}AlₓCo_{y}O_{z}

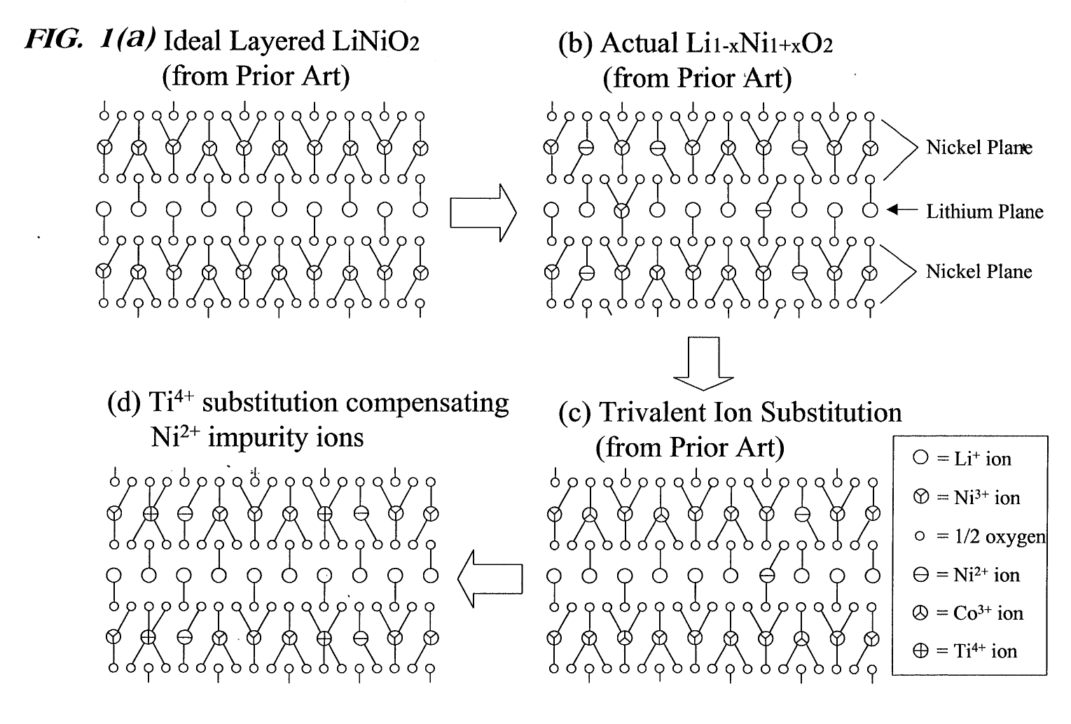

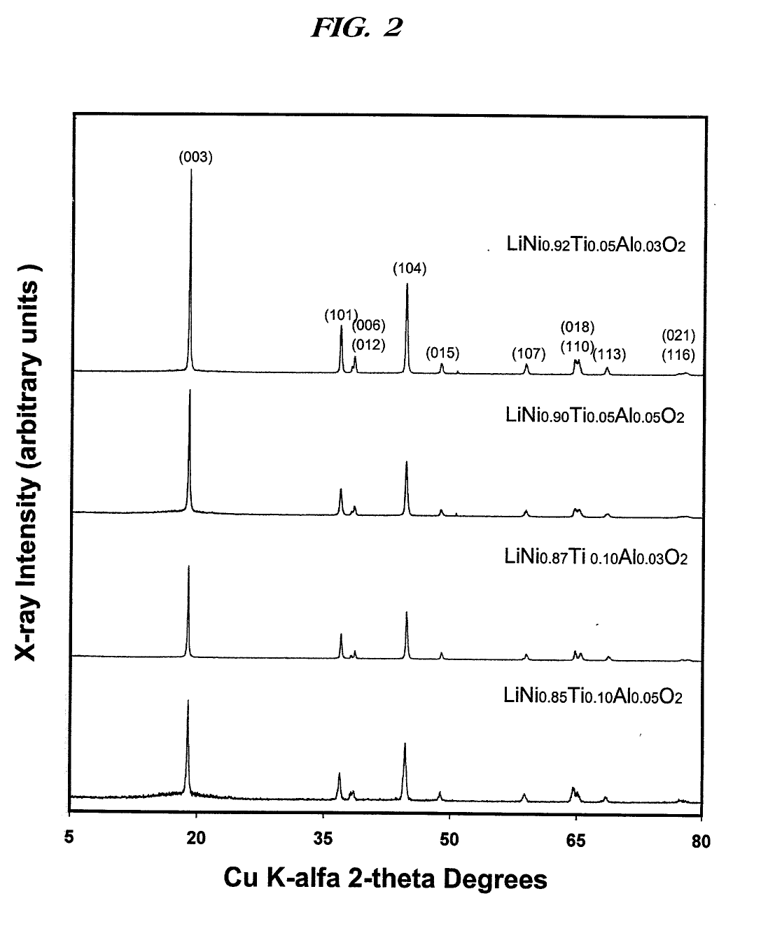

FIG. 2 shows X-ray powder diffraction patterns of the substituted lithium nickel oxides LiᵤNiᵥTi_{w}AlₓO_{z} formed from heating at 750° C. for 30 hours. The samples were obtained by a solid state reaction between lithium, nickel hydroxides, titanium oxide (anatase), and aluminum hydroxide. All compositions of samples 1-4 represent phase pure shown in FIG. 1. Since excess lithium hydroxide was provided to compensate the lithium losses, the Bragg intensity ratio R₍₀₀₃₎=I₍₀₀₃₎/I₍₁₀₄₎ shows relatively high value of 1.3-2.5 which can serve as a quantitative criterion for the stoichiometry and degree of order in layered lithium nickel oxides system.

### EXAMPLE 3

### Charge/Discharge Characteristics and Cyclability

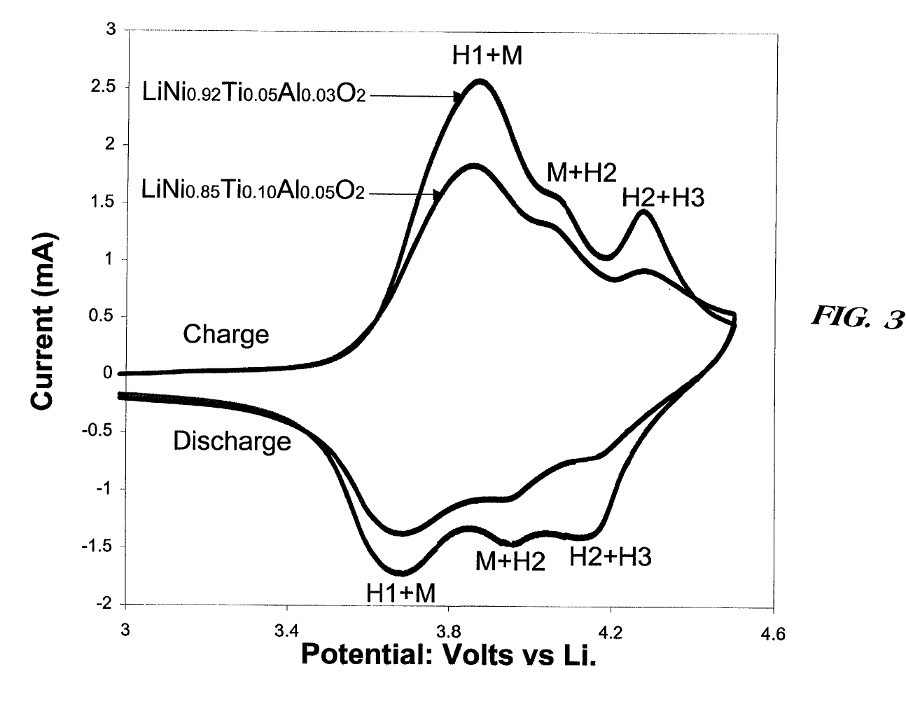

FIG. 3 shows cyclicvoltammetry curves of the substituted lithium nickel oxides LiᵤNiᵥTi_{w}AlₓO_{z} samples. During the lithium extraction/insertion process, the LiNiO₂ host structure has been known to have undergo three distinct phase transitions. The LiᵤNiᵥTi_{w}AlₓO_{z} sample shows two-phase reactions of hexagonal to monoclinic (H1-M) at 3.7 V, monoclinic to hexagonal (M-H2) at 4.05 V, and hexagonal to hexagonal (H2-H3) at 4.2 V, while it is charged. Actually, it shows much broader peaks compared to the results of unsubstituted LiNiO₂ in the literature with small amounts of Ti⁺³ substitution. As the amounts of substituents increase, the sharp peaks become even broader, and especially the peak positions at 3.8 V where only a single monoclinic phase is known to exist. It is suggested, that the host lattice can avoid destructive structural phase transitions by having only a one-phase reaction. In fact, in the case of relatively large amounts of titanium and aluminum samples, no discernible sharp peaks were observed.

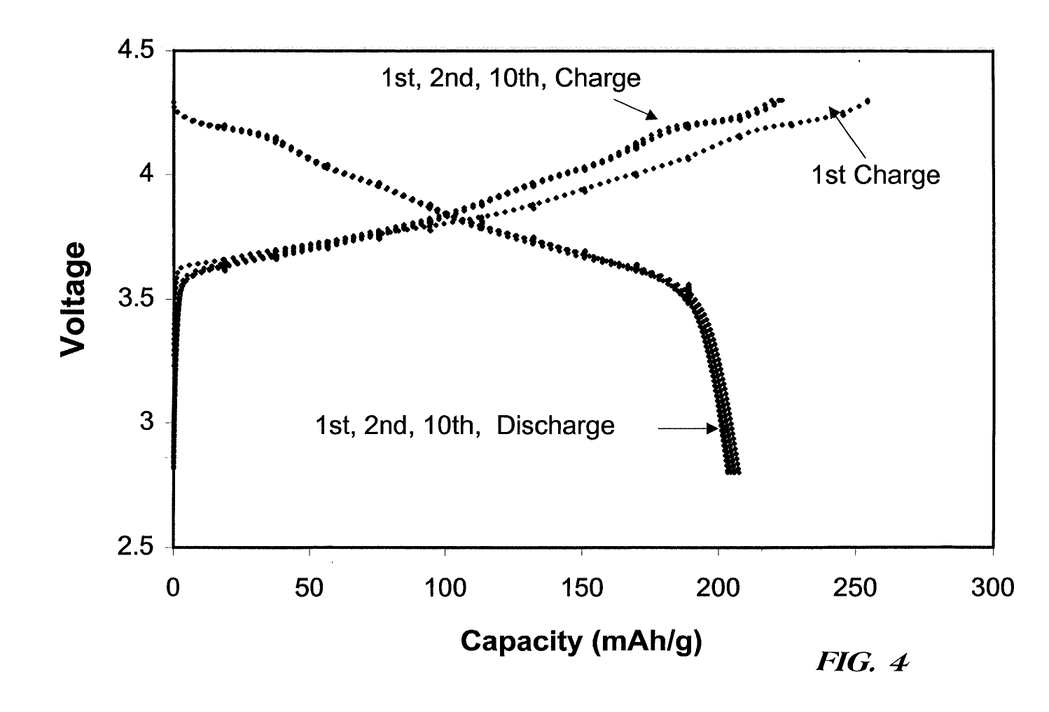

FIG. 4 shows charge and discharge curves of the substituted lithium nickel oxides LiNi_{0.92}Ti_{0.05}Al_{0.03}O₂ prepared in accordance with one embodiment of the present disclosure. The electrode evaluated in FIG. 4 was prepared by mixing the substituted lithium nickel oxides LiNi_{0.92}Ti_{0 05}Al_{0.03}O₂ with carbon and binder. The data were recorded at a current density of 0.2 mA/cm². The data shows good capacity retention over 20 cycles. The electrochemical performance is superior or comparable to that found with the current stabilized LiNiO₂ systems. The new approach of substitution of metallic ions including tetravalent titanium ions leads to the rigid structure and the excellent electrochemical performances.

FIG. 5 shows electrochemical cyclability of the substituted lithium nickel oxides LiᵤNiᵥTi_{w}AlₓO_{z} for various compositions. Data were recorded with a current density of 0.2 mA/cm² in the voltage range of 2.8-4.3. The ordinal numbers refer to the cycle number. Since the tetravalent titanium and trivalent aluminum are not electrochemically active in the voltage range of 4.3-2.8 V, the capacity decreases as the amounts of titanium and aluminum increase.

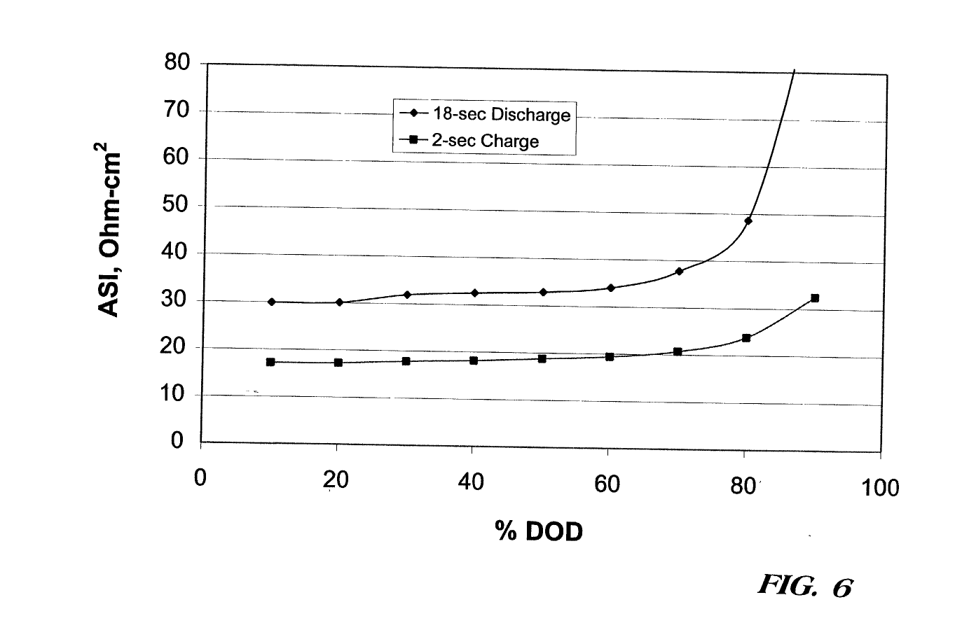

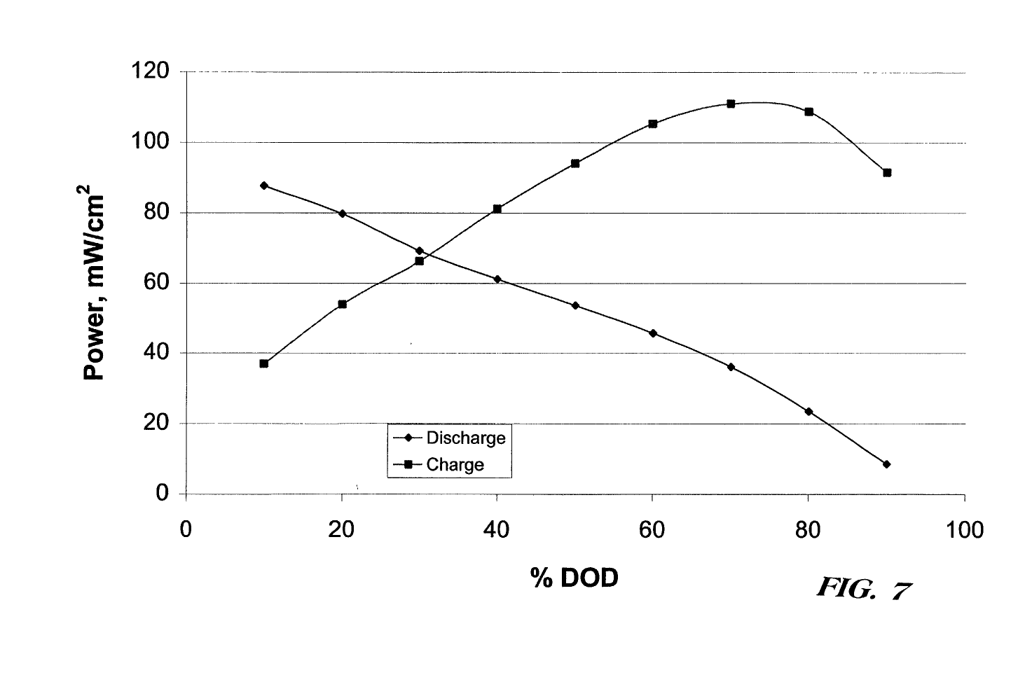

It is assumed that the excellent electrochemical performances of LiᵤNiᵥTi_{w}AlₓCo_{y}O_{z} results from the prevention of the migration of Ni²⁺ ions into the lithium plane by the presence of tetravalent titanium ions. Those samples with the larger amount of titanium have the advantage of just one-phase transition instead of the two-phase oxidation/reduction reaction, which leads to improved capacity retention under extended cycling. Also, LiᵤNiᵥTi_{w}AlₓO_{z} system allows one to produce less expensive and more environmentally friendly electrode materials by avoiding the use of cobalt. FIG. 6 and FIG. 7 show the area specific impedance for hybrid pulse power characterization and power capabilities. This material was found to be very promising for high power and high energy applications.

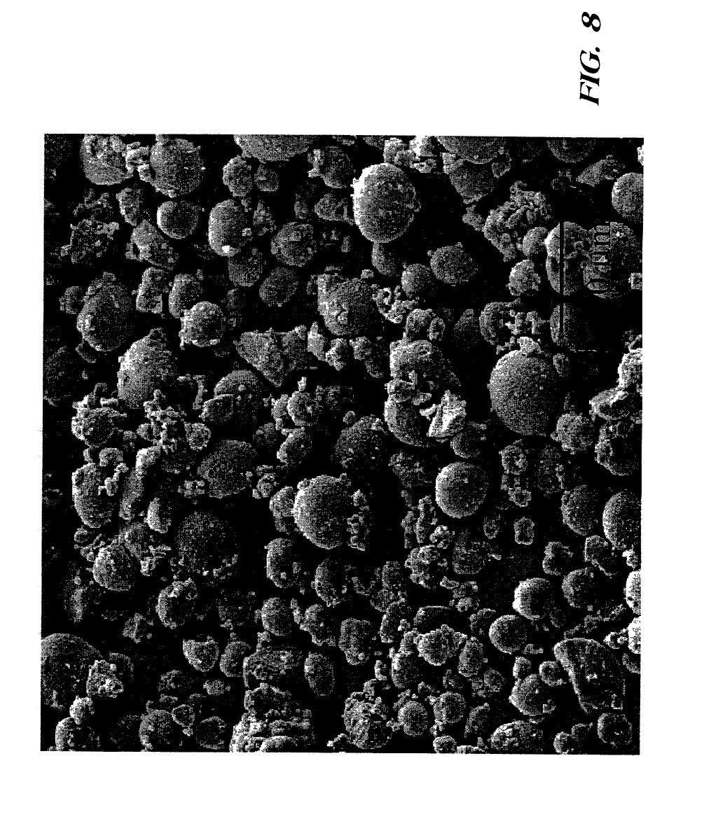

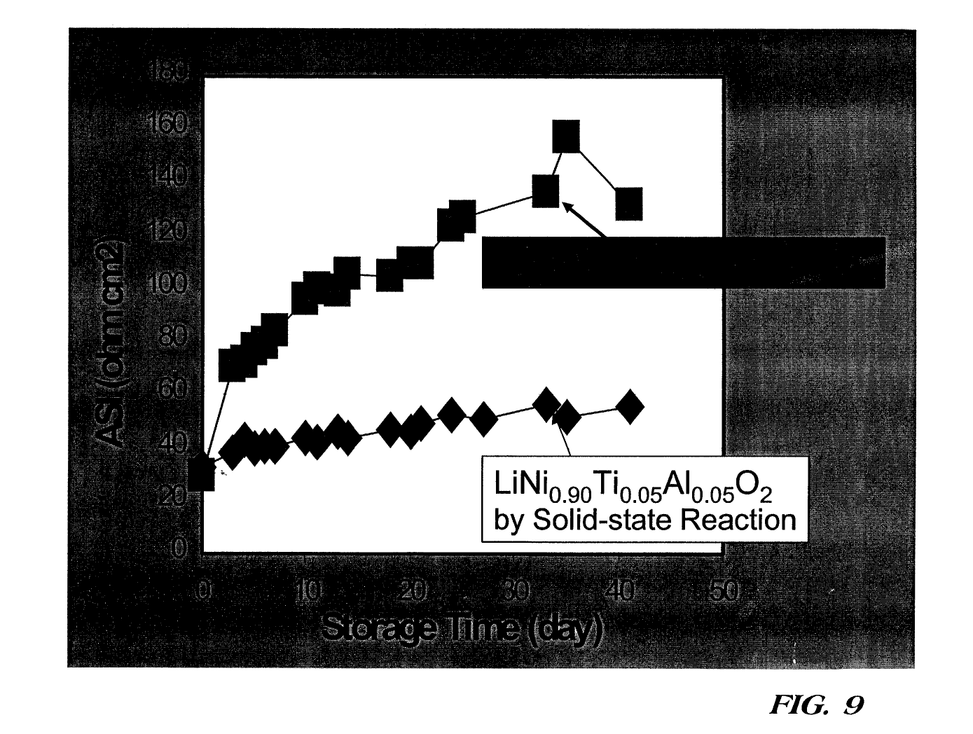

FIG. 8 shows a SEM image of LiNi_{0.92}Ti_{0.05}Al_{0.03}O₂ with its representative spherical morphology of LiᵤNiᵥTi_{w}AlₓCo_{y}O₂ system. The sample powder was prepared by a solid state reaction method. The narrow range of particle size and spherical morphology leads to excellent electrochemical properties and safety characteristics. FIG. 9 shows aging test results, which was performed by investigating an electrode materials after charging to a 90% state of charge at 55° C. It also shows excellent stability characteristics of LiᵤNiᵥTi_{w}AlₓCo_{y}O_{z} system.

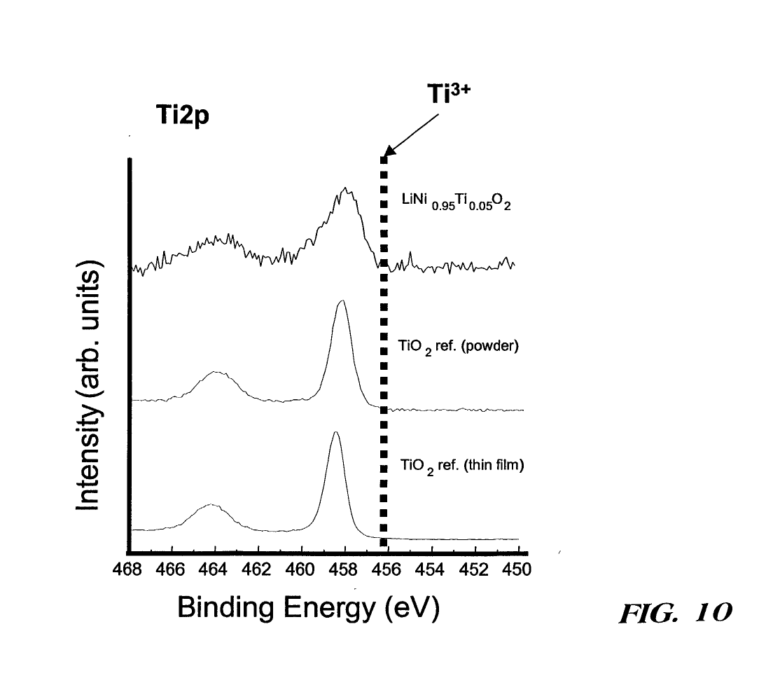

FIG. 10 shows X-ray Photoelectron Spectroscopy data which clearly indicates that the valence state of substituted titanium is 4+. The tetravalent titanium substitution provides the excellent properties, and it is unique feature of this invention.

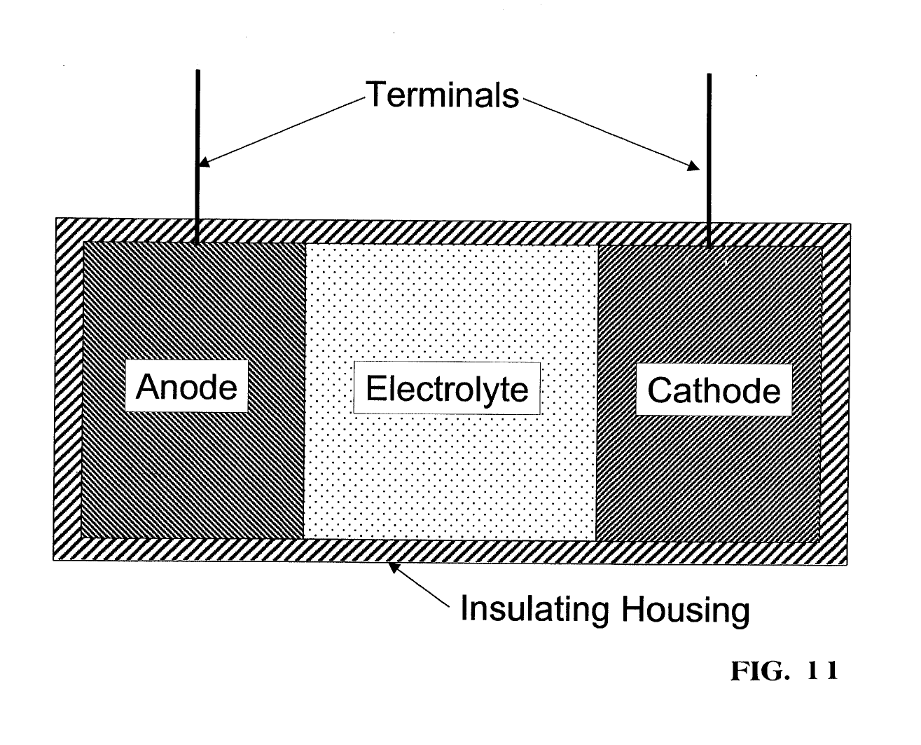

FIG. 11 shows a schematic diagram of a battery with a housing, an electrolyte, an anode and a cathode of the type herein before described.

While the present disclosure may be adaptable to various modifications and alternative forms, specific embodiments have been shown by way of example in this disclosure and described herein. However, it should be understood that the present disclosure is not intended to be limited to the particular forms disclosed. Rather, it is to cover all modifications, equivalents, and alternatives falling within the embodiments of this invention apparent to those skilled in the art. For instance, various changes may be made in the methods and compositions. Also, certain features of the invention may be utilized independently of the use of other features, all as would be apparent to one skilled in the art after having the benefit of this disclosure.

The embodiments of the invention in which an exclusive property or privilege is claimed are defined as follows:

1. An electrode material comprising compositions of LiᵤNiᵥTi_{w}AlₓCo_{y}O_{z}, where u is between about 0.8 and about 1.2, the v is between about 0.5 and about 0.99, w is between about 0.01 and about 0.5, x is between about 0.00 and about 0.5, y is between about 0.00 and about 0.5, and z is between about 1.8 and 2.3

2. The electrode material of claim 1, wherein said substituted lithium nickel oxides comprise crystallographically layered materials.

3. The electrode material of claim 1, wherein the oxidation state of titanium ions is +4.

4. A process of making the materials by using solid state reaction method, solution-based method, or co-precipitation method providing a predetermined mixture of the salts of lithium, nickel, titanium, aluminum and cobalt; and b) heating said mixture to about 550° C. to about 950° C. for a period of time sufficient to form crystallographically layered materials having a formula LiᵤNiᵥTi_{w}AlₓCo_{y}O_{z}, where u is between about 0.8 and about 1.2, the v is between about 0.5 and about 0.99, w is between about 0.01 and about 0.5, x is between about 0.00 and about 0.5, y is between about 0.00 and about 0.5, and z is between about 1.8 and 2.3.

5. The process of claim 4, wherein said the materials comprise LiᵤNiᵥTi_{w}AlₓCo_{y}O_{z} material which is prepared by solid-state reaction method and has spherical morphology, excellent capacity retention, and stability characteristics.

6. The process of claim 4, wherein said heating comprises heating said mixture to about 550° C. and thereafter to about 950° C. for a period of time sufficient to form the crystallographically layered materials.

7. The process of claim 4, wherein said heating comprises heating said mixture to about 750° C. for a period of time sufficient to form the crystallographically phase pure layered materials.

8. The process of claim 4, wherein said lithium salts are one or more of lithium acetate, carbonate, chloride, hydroxide, nitrate, or oxide.

9. The process of claim 4, wherein said nickel sources comprise nickel salts are one or more of nickel acetate, carbonate, chloride, hydroxide, nitrate, or oxide.

10. The process of claim 4, wherein said titanium salts are one or more of titanium acetate, carbonate, chloride, hydroxide, nitrate, or oxides.

11. The process of claim 4, wherein said aluminum salts are one or more of aluminum acetate, carbonate, chloride, hydroxide, nitrate, or oxide.

12. The process of claim 4, wherein said cobalt salts are one or more of cobalt acetate, carbonate, chloride, hydroxide, nitrate, or oxide.

13. The process of claim 4, and further comprising grinding of the crystallographically phase pure layer materials.

14. The process of claim 4, wherein the mixture is heated in an oxygen atmosphere.

15. The process of claim 4, wherein the mixture is heated in air.

16. The process of claim 4, wherein the mixture is heated in an inert atmosphere.

17. The process of claim 4, wherein said mixture is prepared by ball-milling the required amounts of lithium, nickel, titanium, aluminum, and cobalt salts.

18. The process of claim 4, wherein the said mixture is prepared by solution-based mixing.

19. The process of claim 4, wherein the said mixture is prepared by using co-precipitation and thereafter blending.

20. The process of claim 4, wherein said obtained mixture is heated in one of oxygen, air, or inert atmosphere.

21. A battery comprising a battery housing, a negative electrode and a non-aqueous electrolyte and a positive electrode containing a composition of LiᵤNiᵥTi_{w}AlₓCo_{y}O_{z}, where u is between about 0.8 and about 1.2, the v is between about 0.5 and about 0.99, w is between about 0.01 and about 0.5, x is between about 0.00 and about 0.5, y is between about 0.00 and about 0.5, and z is between about 1.8 and 2.3.

22. The battery of claim 21, wherein said positive electrode includes carbon and/or graphite.

23. The battery of claim 21, wherein said positive electrode includes crystallographically phase pure layered materials and a binding material.

24. The battery of claim 23, wherein said crystallographically phase pure layered materials and binder have between 5 to 40 weight percent carbon.
